(19) United States
(12) Patent Application Publication
(10) Pub. No.: US 2010/0112363 A1
(43) Pub. Date: May 6, 2010

(54) WATERBORNE ADHESIVE COMPOSITIONS FOR USE IN BONDING TO FIRE RETARDANT TREATED WOOD AND WOOD COMPOSITES

(75) Inventor: Ronald J. Skrzyniarz, Easton, PA (US)

Correspondence Address: Henkel Corporation, 10 Finderne Avenue, Bridgewater, NJ, 08807, US

(73) Assignee: HENKEL CORPORATION, Rocky Hill, CT (US)

(21) Appl. No.: 12/262,364

(22) Filed: Oct. 31, 2008

(51) Int. Cl. B32B 23/04; B32B 27/06; B32B 37/12

(52) U.S. Cl. 428/481; 428/533; 156/60

(57) ABSTRACT

The invention relates to waterbome adhesive compositions that make them suited for use in bonding to fire retardant treated wood and wood composites. The waterborne adhesive comprises resin emulsion stabilized by dextrin and/or surfactant. The invention is also directed to a method for bonding fire retardant treated wood or wood composite substrate to a similarly treated or to a dissimilar substrate. The invention is further directed to articles manufactured using the adhesive composition of the invention. The manufactured fire retardant articles are well suited for use in public places where large number of people assemble, e.g. offices, schools, hospitals, and the like.

### FIELD OF THE INVENTION

The invention relates to waterborne adhesive compositions. The compositions of the invention have properties that make them particularly well suited for use in bonding to fire retardant treated wood and wood composites.

### BACKGROUND OF THE INVENTION

Wood and wood composites, in particular when used in the manufacture of articles to be used in public places, such as in office buildings, schools, hospitals and the like, are typically treated with certain fire retardant chemicals to make them more fire resistant. Among various fire retardant chemicals, boron compounds, are often used since they are low in cost and mammalian toxicity, and have a minimum environmental impact. When fire resistant articles are manufactured using conventional wood adhesives, the adhesive will gel upon contact with wood and wood composites that have been treated with fire retardants. The fire retardant chemicals in the wood and wood composites crosslink the adhesive and form a rubbery precipitate, resulting in a poor, weak bond at the interface. Such conventional used wood adhesives are manufactured using resin emulsions stabilized with polyvinyl alcohol. While neoprene-based contact cements have, alternatively, been used as a wood adhesive, these types of adhesives are difficult to use since the wood must first be sanded to open the pores, at least double the amount of adhesive is required to be used, and heat must be applied in order to form the bond.

There continues to be a need in the art for wood adhesives that can form a good bond with wood and wood composites that have been treated with fire retardant compounds. The current invention addresses this need.

### SUMMARY OF THE INVENTION

The invention provides waterborne adhesive compositions having good adhesion properties to fire retardant treated wood and wood composites.

One embodiment of the invention is directed to a waterborne adhesive comprising at least one resin emulsion such as a polyvinyl acetate and/or an ethylene vinyl acetate emulsion stabilized by dextrin and/or surfactant. In one embodiment, the resin emulsion is dextrin stabilized polyvinyl acetate. In another embodiment, the resin emulsion is both dextrin and surfactant stabilized polyvinyl acetate. The adhesive may desirably also comprises at least one filler and may, optionally, further comprise a phenolic resin, defoamer, rheology modifier, surfactant and/or other conventional additive.

Another embodiment of the invention is directed to a method for bonding fire retardant treated wood or wood composite substrate to a similarly treated wood or wood composite substrate or to a dissimilar substrate. The method comprises applying the adhesive composition of the invention to a first substrate, bringing a second substrate in contact with the composition applied to the first substrate, and subjecting the applied composition to conditions which will allow the composition to dry and cure. In one embodiment, both the first and the second substrate is a fire retardant treated wood or wood composite.

Yet another embodiment of the invention is directed to articles manufactured using the adhesive composition of the invention. Articles of the invention will comprise at least one substrate that is a wood or wood composite treated to give it fire retardant properties. Encompassed articles include, but are not limited to, elevator cabs, kiosks, passenger boarding bridges, architectural woodwork, wall sheathing, wainscoting, display panels, door components, furniture including classroom and office furniture such as desks and bookshelves, fixtures, commercial case goods, shelving, cabinets, countertops, and the like. The manufactured fire retardant articles are well suited for use in public places where large number of people assemble, e.g. offices, schools, hospitals, and the like.

### DETAILED DESCRIPTION OF THE INVENTION

The term “waterborne adhesive” refers to an adhesive composition, the components of which are carried in an aqueous medium. The waterborne adhesives of the invention comprise at least one resin emulsion, i.e., a resin that has been suspended or dispersed in water As the water evaporates, the adhesive hardens and adheres to the substrate.

As used herein, the terms “fire retardant substrate” and “fire retandant treated substrate” refer to wood and wood composites that have been treated to increase its resistance to fire and include Borax treated wood and wood composites. “Wood composites” encompass, for example, wood veneers, high-pressure laminants, chipboard, particleboard, medium density fiberboard, high density fiberboard, oriented strandboard, hardboard, hardwood plywood, veneer core plywood, isocyanate or phenolic impregnated strawboard, and wood composites made from wood fiber and polymers, such as recycled polyethylene.

It has been discovered that certain types of waterborne adhesives, when used as a wood adhesive, strongly adheres to and can be used to bond together substrates (wood and wood composites) treated with substance, such as Borax, to increase fire retardancy.

Hereinafter, fire retardant treated wood and wood composites will be referred to, in the alternative, as “fire retardant substrate” or “fire retandant treated substrate” Resin emulsions which may be used in the practice of the invention are polyvinyl acetate, ethylene vinyl acetate or various blends thereof. In one embodiment a blend of two or more polyvinyl acetate emulsions are used. The resins used to prepare the emulsions will generally have a glass transition temperature from about −15° C. to about 40° C., more typically from about −5° C. to about 30° C. The resin emulsion used in the practice of the invention are those that are stabilized with dextrin, surfactant, or a mixture thereof. Dextrin stabilized, surfactant stabilized, and dextrin and surfactant stabilized resin emulsions are useful in the practice of the invention.

Surfactants that can be used to stabilized resins in the preparation of emulsions used in the practice of the invention include, but not limited to, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, esters of sulfosuccinic acid, alkyl quaternary ammonium salts, alkyl quaternary phosphonium salts, ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof.

The amount of dextrin and/or surfactant used to stabilize polyvinyl acetate and ethylene vinyl acetates range from about 0.05 to 10 dry weight percent, preferably 0.2 to about 6 dry weight percent, based on the total emulsion, in the practice of the invention.

While the solids content of the resin emulsion is not particularly limiting to the practice of the invention, high solids resin emulsions, particularly from about 50 to about 70% solids in water (w/w) are typically preferred for used in the practice of the invention

Dextrin-stabilized polyvinyl acetates are commercially available from Celanese, under the trade name Resyn®1072.

It has been found that adhesives comprising the stabilized resin emulsions of the invention can be used as a wood adhesive to form a strong bond with fire retardant treated substrates.

The adhesive may also contain a filler. The addition of a filler controls the rheology of the adhesive. Suitable fillers known and used in the adhesive arts include polysaccharides, calcium carbonate, clay, mica, nut shell flours, silica, talc and wood flour.

One preferred filler is a polysaccharide. Polysaccharides useful in the invention include starch, dextrin, cellulose, gums or combinations thereof. Particularly useful are the starches and dextrin including native, converted or derivatized. Such starches include those derived from any plant source including maize (corn), potato, wheat, rice, sago, tapioca, waxy maize, sorghum and high amylose starch such as high amylose corn, i.e. starch having at least 45% amylose content by weight. Starch flours may also be used. Also included are the conversion products derived from any of the former bases, such as, for example, dextrin prepared by hydrolytic action of acid and/or heat; fluidity or thin boiling starches prepared by enzyme conversion or mild acid hydrolysis; oxidized starches prepared by treatment with oxidants such as sodium hypochlorite; and derivatized or modified starches such as cationic, anionic, amphoteric, non-ionic, crosslinked and hydroxypropyl starches. Other useful polysaccharides are cellulose materials such as carboxymethylcellulose, hydroxypropyl cellulose and hydroxypropyl methylcellulose, and gums such as guar, xanthan, pectin and carrageenan may also be used in the practice of the invention. Modified starches include, but are not limited to, those modified with an alkyl succinic anhydride. Preferred are octenyl succinic anhydride (OSA) and dodecenyl succinic anhydride (DDSA) modified starches or dextrin.

The adhesive may further optionally include a phenolic resin. The use of phenolic resin in the adhesive composition enhances water resistance of the cured adhesive. Particularly preferred phenolic resins include those resins that give off low or no volatile products upon curing and do not involve the use of formaldehyde or formaldehyde-producing agents in their preparation. The use of formaldehyde introduces environmental and toxicological problems in the preparation, fabrication, and even in the long term use of such materials. These are points of attack for high temperature oxidative degradation. Exemplary phenolic resin includes Arofene® 72155-W55 available from Ashland Chemicals, Schenectady SP-103, SP103H, SP-12, SP-134, SP-134H, SP-154, SP-154H, SP-184, SP-274 and SP-8219 available from Schenectady Chemical.

In addition to fillers, other additives typical of adhesive compositions may be added to the composition. Said additives include, but are not limited to, defoamers, thickeners, rheology modifiers, plasticizers, acids, waxes, synthetic resins, tackifiers, preservatives, bases such as sodium hydroxide, dyes, pigments, UV indicators, surface-active agents (anionic, cationic, amphoteric, or nonionic surfactants) and other additives commonly used in the art.

Adhesive composition of the invention will generally comprise, by weight, about 85.0% to about 99.0% dextrin, surfactant or dextrin and surfactant stabilized resin emulsion, about 0.1% to about 10% filler, up to about 5% phenolic resin, and up to about 5% other types of conventional additives. The cured adhesive composition will comprise about 50.0% to about 99.0%, more typically from about 70.0% by to about 97.0% by dry weight of the resin emulsion (without water), and from 0.1% by weight to about 10.0% by dry weight of filler (without water).

The adhesive may be applied by any method known in the art. Typically one substrate is coated with adhesive. A second substrate is placed atop of the adhesive with pressure to bond the substrates together. At least one substrate is a fire retardant treated substrate. The adhesive is used to bond the fire retardant treated substrate to a similarly treated substrate or to another substrate, such as medium density fiberboard or high pressure laminate. In one embodiment the first and the second substrate are both fire retardant treated substrates. Pressure may be applied to the construction by any suitable means. Typical bonding pressure is about 50 psi, although higher pressure is possible. Preferably, pressure is applied via a roller during a cold or hot press process.

Heat may also be introduced by means of heating elements, or by heating rollers. The use of heat decreases the overall time to bond the substrates together.

The method of the present invention can be advantageously utilized in the manufacture of elevator cabs, kiosks, passenger boarding bridges, architectural woodwork, wall sheathing, wainscoting, display panels, door components, furniture (desks, chairs, etc.), fixtures, commercial case goods, shelving, cabinets, countertops, and the like.

The invention is further illustrated by the following non-limiting examples.

### EXAMPLES

TABLE 1

| Components | (g) |
|---|---|
| Dextrin stabilized polyvinyl acetate | 950 |
| (Resyn ® 1072, Celanese) | |
| (63% solids content in water) | |
| Filler (Dextrin, National Starch) | 30 |
| Phenolic resin (Arofene 72155-W55, | 20 |
| Ashland Chemical Company) | |
| Defoamer (Nopco NXZ, Nopco Paper Technology) | 10 |

The adhesive was prepared by combining all of the components in Table 1 and mixing at room temperature with stirring for about 30 minutes.

### Cold Press

A bondline thickness of about 6 mils of the above adhesive composition was applied on a 3″×3″ medium density fiberboard (MDF). A wood veneer, also 3″×3″ was applied on top of the adhesive. Both the MDF and the wood veneer had been treated with Borax. A pressure of 50 psi was applied on top of the veneer for 30 minutes at room temperature. No gelling or other precipitation of the applied adhesive was observed. The MDF and wood veneer were strongly bonded together.

### Hot Press

A bondline thickness of about 6 mils of the above adhesive composition was applied on a 3″×3″ medium density fiberboard (MDF). A wood veneer, also 3″×3″ was applied on top of the adhesive. Both the MDF and the wood veneer had been treated with Borax. A pressure of 50 psi at 200° F. was applied on top of the veneer for 30 seconds using Carver hot press. No gelling or other precipitation of the applied adhesive was observed. The MDF and wood veneer were strongly bonded together.

### Results for Burning Characteristics

Articles made with the adhesive of the invention were found to pass the ASTM E 84 Standard Test for Surface Burning Characteristics of Building Materials, the ASTM C 236 Guarded Hot Box Test and the UL 723 Test for Surface Burning Characteristics of Building Materials.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. An article comprising a fire retardant treated wood or wood composite and an adhesive, wherein the adhesive comprises resin emulsion stabilized with dextrin, surfactant or a mixture thereof and water, and the fire retardant treated wood or wood composite is a boron treated wood or wood composite.

2. (canceled)

3. The article of claim 1 wherein the adhesive comprises a resin emulsion having a glass transition temperature range of about −5° C. to about 30° C.

4. The article of claim 1 wherein the adhesive comprises a resin emulsion selected from the group consisting of a polyvinyl acetate, an ethylene vinyl acetate, and mixtures thereof.

5. The article of claim 4 wherein the adhesive comprises a blend of two or more polyvinyl acetates.

6. The article of claim 1 wherein the adhesive comprises a dextrin stabilized polyvinyl acetate.

7. The article of claim 1 wherein the adhesive comprises a dextrin and surfactant stabilized polyvinyl acetate.

8. The article of claim 1 wherein the adhesive further comprises a filler.

9. The article of claim 8 wherein the filler is a polysaccharide.

10. The article of claim 9 wherein the polysaccharide is a dextrin.

11. The article of claim 1 wherein the adhesive further comprises a phenolic resin.

12. The article of claim 11 wherein the phenolic resin gives off low or no formaldehyde upon curing.

13. The article of claim 12 wherein the adhesive further comprises a surface active agent, a defoamer, a preservative, rheology modifier and/or a UV indicator.

14. The article of claim 8 wherein the adhesive comprises from about 50.0 to about 99.0 weight % of the resin emulsion and from about 0.1 to about 10.0% of the filler, based on dry weight.

15. The article of claim 14 wherein the adhesive comprises from about 70.0 to about 97.0 weight % of the resin emulsion, based on dry weight.

16. The article of claim 1 which is a chair, desk, or bookshelf.

17. A method of manufacturing a fire retardant article comprising:
(a) applying an adhesive composition comprising resin emulsion stabilized with a dextrin, a surfactant or a mixture thereof, to a first substrate
(b) bringing a second substrate in contact with the adhesive composition applied to the first substrate; and
(c) subjecting the applied composition to conditions which will allow the composition to cool and form a set bond;
wherein at least one of said first or second substrate is a fire retardant treated wood or wood composite.

18. The method of claim 17 wherein said conditions which will allow the composition to cool and form a set bond comprises heat and pressure.

19. The method of claim 17 wherein the adhesive composition comprises a dextrin stabilized polyvinyl acetate.

20. The method of claim 17 wherein said at least one of said first or second substrate is a borax treated substrate.
